(19) United States
(12) Patent Application Publication
(10) Pub. No.: US 2022/0017814 A1
(43) Pub. Date: Jan. 20, 2022

(54) COATED PROPPANTS

(71) Applicant: Dow Global Technologies LLC, Midland, MI (US)

(72) Inventors: Praveen Agarwal, Lake Jackson, TX (US); Yifan Dong, Lake Jackson, TX (US); Arjun Raghuraman, Pearland, TX (US); Aayush Shah, San Francisco, CA (US); Juan Carlos Medina, Lake Jackson, TX (US); Kshitish Patankar, Midland, MI (US); Mark F. Sonnenschein, Midland, MI (US)

(21) Appl. No.: 17/295,115

(22) PCT Filed: Oct. 31, 2019
(86) PCT No.: PCT/US2019/059189

§ 371 Date: May 19, 2021

Related U.S. Application Data
(60) Provisional application No. 62/773,231, filed on Nov. 30, 2018.

(51) Int. Cl. C09K 8/80; C09K 8/68

(52) U.S. Cl. CPC C09K 8/805; C09K 8/68

(57) ABSTRACT

Coated proppant particles are prepared from a coating composition that includes at least one polyisocyanate and an isocyanate trimerization catalyst. The coating composition preferably is devoid of an effective amount of a urethane, urea and carbodiimide catalyst. The coating composition cures rapidly at moderate temperatures, and bonds to itself well under conditions of heat and pressure as are experienced by the particles in subterranean formations.

This invention relates to proppants and methods of making proppants.

Oil and natural gas are obtained by drilling into subterranean reservoirs. Often, the oil and gas products are trapped within a formation that has low porosity and low permeability and cannot be extracted easily. These formations are often hydraulically fractured by pumping fluids at high pressure and velocity into the formation. Trapped oil and gas are released from the fractured formation. The fracturing also forms flow channels through which those products can travel into the well bore, from which they can be extracted.

Because of high localized pressures, those fractures and fissures tend to close when the fracturing step is completed. This shuts off the flow channels, reducing or eliminating the flow of product to the well bore. To avoid this problem, proppants often are injected into the well along with the hydraulic fracturing fluid. The proppants are solid materials that occupy space in the fractures and thus prevent them from becoming closed off. The proppants are in the form of small particles. Sand is widely used because it is readily available, inexpensive, and has a suitable particle size. Even though the proppant particles occupy space within the fractures, there is room in spaces between them for the oil and gas products to flow.

The flow of oil and gas can wash the proppant out of the formation and back into the well, a phenomenon known as “proppant flowback”. This is undesirable because the fractures partially or entirely close once the proppant is washed away, leading to decreased production rates and downtime. The proppant needs to be separated from the product, as well. The proppants, especially silica sand, are abrasive and can damage submersible pumps and other equipment if they are washed back to the wellbore.

A common way to reduce proppant flowback is by applying a polymeric coating to the particles. At the temperature and pressure conditions in the well, the polymer coating causes the particles to stick together and also to the underlying rock formation. This makes the particles more resistant to being washed out of the fractures without rendering the formation containing the bonded proppant particles unduly impermeable to the flow of oil and gas out of the well.

Among the polymers that have been used are phenolic resins, various epoxy resins, and isocyanate-based polymers that have urethane, urea, carbodiimide, isocyanurate and like linkages. Polymer-coated proppants of this type are described, for example, in WO 2017/003813, US Published Patent Application Nos. 2008-0072941 and 2016-0186049 and U.S. Pat. Nos. 9,725,645, 9,896,620 and 9,714,378.

While good performance has been obtained in some cases, these polymer systems suffer from significant drawbacks. A very significant issue is the need to use quite high temperatures during the coating process. Temperatures of 120° C. or even higher are quite commonly needed to obtain an adequate cure within a reasonable time. If inadequately cured, the polymer coating will not perform correctly in the formation. The coating or components thereof can leach out during transportation and handling, or in the subterranean formation, which is undesirable from an environmental and occupational hazard standpoint.

Even though the polymer coating is usually applied in small amounts such as a few weight percent based on the weight of the proppant particle, the entire mass of the proppant must be heated, which is adds greatly to the expense of the coating process. The ability to use lower temperatures would greatly reduce the energy consumption, particularly if short curing times are also achieved.

Another problem is that the isocyanate-based coating formulations tend to be somewhat complex, which leads to handling, logistical and cost disadvantages. Still another problem with the polymer systems is they are not readily adapted to be used in low cost processes such as spray coating processes. Spray coating, if feasible, represents an inexpensive, fast and easily controlled manner of coating the proppant particles.

Therefore, a new proppant coating formulation is desired. The coating formulation should be curable at moderate temperatures, and cure at those moderate temperatures in a reasonably short period of time. The coating formulation preferably contains a minimum number of ingredients, to minimize cost and other problems associated with complex formulations. It preferably is amenable to being applied using low cost spray coating methods. The coated proppant also must meet the demands of the application. After coating, the proppant particles should be free-flowing rather than agglomerated so the particles can be carried into the formulation with the fracturing fluid. Once in place, the coated particles need to bond under the local heat and pressure conditions to reduce or eliminate proppant flowback.

This invention is a method for forming a coated proppant. The method comprises applying a coating composition to the surface of solid substrate particles, wherein the solid substrate particles are thermally stable to a temperature of at least 100° C., wherein the coating composition comprises at least one polyisocyanate and an isocyanate trimerization catalyst, and curing the coating composition at an elevated temperature for a period of up to 10 minutes on the surface of the substrate particles to form a solid polymeric coating at the surface of the solid substrate particles, thereby forming the coated proppant.

The invention is also a coated proppant particle made using the method. In particular embodiments, the invention is a coated proppant particle comprising a substrate particle having a polymeric coating that weighs 0.1 to 10 weight percent of the weight of the substrate particle, wherein the polymeric coating is a polyisocyanurate polymer that contains no more than 10 mole-% urethane, urea and/or carbodiimide linkages. As such, ingredients such as polyether polyols, amines and other isocyanate-reactive materials can be minimized or even eliminated from the coating formulation.

The invention provides significant advantages from both the production and utility points of view. Unlike most prior proppant coatings, the polyisocyanurate coating of this invention forms easily and rapidly at relatively moderate reaction temperatures. This reduces energy requirements, increases production rates and simplifies the production process. Moreover, the uncured coating composition is typically amenable to being applied to the substrate particles by spraying. Because the coated proppant is free flowing, it handles easily during packaging, transportation and use. Once emplaced within a subterranean formation, the particles pack well and bond well to other particles. Coated proppant particles bonded together in such a manner are resistant to proppant flowback.

Accordingly, the invention is also a method of hydraulically fracturing a subterranean formation, comprising injecting a carrier fluid and coated proppant particles of the invention into the subterranean formation to cause the subterranean formation to form fractures, whereby at least a portion of the coated proppant particles are retained in the fractures.

The substrate particle can be of any material that is solid and thermally stable at a temperature of at least 100° C. Preferably, the substrate particle is heat-stable at the curing temperature, at least. In some embodiments, the substrate particle is heat-stable a temperature of at least 140° C., at least 200° C. and more preferably at least 300° C. By “heat-stable”, it is meant that the substrate particle does not melt or otherwise heat-soften to form a flowable material, thermally degrade or decompose, at the stated temperature. Examples of substrate particles include sand and other mineral and/or ceramic materials such as aluminum oxide, silicon dioxide, titanium dioxide, zinc oxide, zirconium dioxide, cerium dioxide, manganese dioxide, iron oxide, calcium oxide, boron nitride, silicone carbide, aluminum carbide, bauxite, aluminum oxide and glass, as well as metals such as metal shot.

The substrate particles may have a particle size such that at least 90 weight-percent of the particles pass through a U.S. 15 mesh screen, which has nominal 4.0 mm openings. In some embodiments, at least 90 weight-% of the substrate particles pass through a U.S. 10 mesh screen, which has nominal 2.0 mm openings, or at least 90 weight-% pass through a 20 mesh screen, which has nominal 1.0 mm openings. In some embodiments least 90 weight-% of the substrate particles preferably are retained on a U.S. 400 mesh screen, a U.S. 200 mesh screen, or U. S. mesh 140 screen, which have nominal openings of 0.037 mm, 0.074 mm and 0.105 mm, respectively. Because the coating weights are low, as described below, the coatings are thin and the coated proppants generally have similar particle sizes.

In its simplest form, the coating composition includes only a polyisocyanate and an isocyanate trimerization catalyst.

The polyisocyanate preferably has an average functionality from about 1.9 to 4, and more preferably from 2.0 to 3.5. It is preferably a liquid at the application temperature. The average isocyanate equivalent weight can be from about 80 to 500, more preferably from 80 to 200 and still more preferably from 125 to 175. The polyisocyanate can be aromatic, aliphatic and/or cycloaliphatic. Exemplary polyisocyanates include, for example, m-phenylene diisocyanate, 2,4- and/or 2,6-toluene diisocyanate (TDI), the various isomers of diphenylmethanediisocyanate (MDI), hexamethylene-1,6-diisocyanate, tetramethylene-1,4-diisocyanate, cyclohexane-1,4-diisocyanate, hexahydrotoluene diisocyanate, hydrogenated MDI (H₁₂ MDI), naphthylene-1,5-diisocyanate, methoxyphenyl-2,4-diisocyanate, 4,4′-biphenylene diisocyanate, 3,3′-dimethoxy-4,4′-biphenyl diisocyanate, 3,3′-dimethyldiphenylmethane-4,4′-diisocyanate, 4,4′,4″-triphenylmethane tri-isocyanate, polymethylene polyphenylisocyanates, hydrogenated polymethylene polyphenylisocyanates, toluene-2,4,6-triisocyanate, and 4,4′-dimethyl diphenylmethane-2,2′,5,5′-tetraisocyanate. Preferred polyisocyanates include MDI and derivatives of MDI such as biuret-modified “liquid” MDI products and polymeric MDI. “Polymeric MDI” is a mixture of MDI (any isomer or mixture of isomers) with one or more polymethylene polyphenylisocyanates that have three or more phenylisocyanate groups. The “Polymeric MDI” may have, for example, an isocyanate equivalent weight of 126 to 150 and a number average isocyanate functionality of 2.05 to 3.5, especially 2.2 to 3.2 or 2.2 to 2.8.

A mixture of two or more polyisocyanates may be present in the coating composition.

The isocyanate trimerization catalyst is a material that promotes the reaction of isocyanate groups with other isocyanate groups to form isocyanurate rings. It preferably is at most a weak urethane and urea-forming catalyst, i.e., has little if any catalytic activity toward the reaction of an isocyanate group with an alcohol, water or a primary or secondary amine group under the conditions of the curing step. It is also preferably at most a weak carbodiimide catalyst, i.e., has little if any catalytic activity toward the reaction of isocyanate groups to form carbodiimides. Useful isocyanate trimerization catalysts include strong bases such as alkali metal phenolates, alkali metal alkoxides, alkali metal carboxylates, quaternary ammonium salts, and the like. Specific examples of such trimerization catalysts include sodium p-nonylphenolate, sodium p-octyl phenolate, sodium p-tert-butyl phenolate, sodium acetate, sodium 2-ethylhexanoate, sodium propionate, sodium butyrate, the potassium analogs of any of the foregoing, trimethyl-2-hydroxypropylammonium carboxylate salts, and the like.

The isocyanate trimerization catalyst is present in catalytic quantities, such as from 0.05 to 10 parts by weight per 100 parts by weight of the polyisocyanate. In specific embodiments, this catalyst may be present in an amount of at least 0.1, 0.25, 0.5 or 1 part by weight per 100 parts by weight of the polyisocyanate, and may be present in an amount up to 7.5, up to 5 or up to 2.5 parts by weight per 100 parts by weight of the polyisocyanate.

All other components of the coating composition are optional and can be excluded from it. In particular, it is preferred that certain materials are absent or, if present, are present in only small amounts. Such materials include:

a) Urethane, urea and/or carbodiimide catalysts (other than the isocyanate trimerization catalyst), i.e., catalysts for the reaction of an isocyanate group toward an alcohol, water, a primary amino group or a secondary amino group, and/or of an isocyanate group with another isocyanate group to form a carbodiimide. If present at all, such catalysts are present in only very small quantities, such as no more than 0.01 part by weight per 100 parts by weight of the polyisocyanate. Among such catalysts are tin (II) and tin (IV) catalysts, catalysts that contain other Group III to Group XV metals (IUPAC 1 Dec. 2018 Periodic Table of Elements); tertiary amine compounds, amidines, tertiary phosphines, phospholene oxides and the like, each of which preferably are absent or if present are present only in small quantities as indicated in the previous sentence.

b) Alcohols, including both monoalcohols and polyalcohols. If present at all, these are preferably present in quantities no greater than 10 parts by weight, more preferably no more than 5 parts by weight, per 100 parts by weight of the polyisocyanate. It is noted that commercial isocyanate trimerization catalyst products may contain alcohols having hydroxyl equivalent weights of up to 100 as a solvent or diluent; such small amounts of alcohols as are present in such catalyst products generally are suitable for use in the coating composition. It is especially preferred that the coating composition contains no more than 5 parts, especially no more than 1 part and even more preferably no more than 0.01 part, of alcohols having an equivalent weight of greater than 100, on the foregoing basis.

c) Compounds having one or more primary and/or secondary amino groups. If present at all, these are preferably present in quantities no greater than 5 parts by weight, more preferably no greater than 2.5 parts by weight or no greater than 1 part by weight, per 100 parts by weight of the polyisocyanate.

The coating composition may include certain optional components. An optional component of particular interest is a finely divided particulate solid, which does not melt, degrade or decompose under the conditions of the coating step or use of the coated proppant in a subterranean formation. The finely divided particulate solid should have a particle size much smaller than that of the substrate particles. The particle size may be, for example, smaller than 100 μm, smaller than 10 μm, smaller than 1 μm, smaller than 500 nm or smaller than 100 nm, as measured by dynamic light scattering methods. The particle size may be at least 5 nm, at least 10 nm or at least 20 nm. Examples of such finely divided particles include fumed silica, various metals, various metal oxides, talc steatite, other ceramic particles, finely divided thermoset polymers, and the like. Fumed silica is particularly preferred.

The amount of finely divided particulate solid, when present, may be, for example, at least 1, at least 5, at least 10 or at least 25 parts by weight per 100 parts by weight of the polyisocyanate and up to 100, up to 75 or up to 50 parts by weight per 100 parts by weight of the polyisocyanate.

As discussed below, a finely divided particulate solid may be applied to the substrate particles as part of the coating composition (i.e., at the same time the polyisocyanate and/or isocyanate trimerization catalyst are applied, prior to curing). Alternatively, the finely divided particulate solid may be applied after the coating composition has been applied and at least partially (or entirely) cured.

Water may be present in the coating composition. Although not necessary, water is sometimes useful as a carrier for the finely divided particulate solid, which in such cases may be provided in the form of a dispersion of the particles in water or an aqueous phase containing water. In cases in which the finely divided particulate solid is an ingredient of the coating composition, it is conveniently provided in the form of such a dispersion, and in such cases the coating composition may contain a significant quantity of water for that reason. Water, if present at all, may be present in an amount of, for example, up to 100 parts by weight per 100 parts by weight of the polyisocyanate and may be present in smaller amounts such as up to 75 or up to 50 parts by weight on the same basis. Although water can react with isocyanates to form ureas, this is believed to be minimized due to the substantial absence of a catalyst for the reaction of water with an isocyanate group. Urea formation can be avoided or minimized by applying the dispersion of finely divided particulate solid after the coating composition has been applied and at least partially cured.

Similarly, the coating composition may contain one or more other solvents or diluents not reactive toward isocyanate groups, which may be present, for example, as a liquid phase in which the finely divided particles, the isocyanate trimerization catalyst or both are dispersed.

Another optional ingredient is an adhesion promoter. Examples of suitable adhesion promoters include hydrolysable silane compounds such as amino silanes (for example, 3-aminopropyl triethoxysilane) and epoxy silanes.

In specific embodiments, the coating composition includes i) the polyisocyanate, ii) the isocyanate trimerization catalyst, iii) finely divided fumed silica particles, (iv) 0 to 10 parts (especially 0 to 5 parts) by weight), per 100 parts by weight of the polyisocyanate, of a mono- and/or polyalcohol, which alcohol if present preferably is a diluent for the isocyanate trimerization catalyst, v) 0 to 100 parts (preferably 0 to 50 parts) by weight of water per 100 parts by weight of the polyisocyanate, which is preferably provided as a liquid phase in which the fumed silica particles are dispersed, vi) 0 to 0.01 weight percent of one or more catalysts for the reaction of an isocyanate group toward an alcohol, water, a primary amino group or a secondary amino group, or of an isocyanate group with another isocyanate group to form a carbodiimide and vii) 0 to 2.5 parts (especially 0 to 1 part) by weight of one or more primary amino and/or secondary amino compounds. In some embodiments the coating composition includes only ingredients i)-vi) (vii)) being absent) and in still other embodiments the coating composition includes only ingredients i)-v) (vi and vii) being absent), only ingredients i), ii), iii) and iv) (v), vi) and vii) being absent) or only ingredients i), ii) and iii) ((iv, v, vi and vii) being absent). The coating composition may include only ingredients i) and ii).

The various ingredients of the coating composition can be combined to form a mixture that is applied to the substrate particles. Alternatively, the various ingredients can be applied sequentially to the substrate particles, or in various subcombinations. If the coating composition is not fully formulated before applying, it is preferred to first apply the polyisocyanate by itself or some subcombination of ingredients that include the polyisocyanate, followed by the remaining ingredients.

For example, it may be convenient to apply the polyisocyanate first, followed by applying the other ingredients together, singly or in some combination. In such a case, the catalyst may be applied next after the polyisocyanate, followed by or accompanied by the finely divided particles (if used), which are preferably dispersed in water or other liquid phase. In other embodiments of the invention, finely divided particles may be applied after the coating composition is applied, either during the curing step or after the polyisocyanate has cured to form the polyisocyanurate coating.

In other embodiments, the polyisocyanate and at least a portion of the isocyanate trimerization catalyst are combined and applied together, followed by a dispersion of finely divided particles. In such an embodiment, a portion of the catalyst may be applied after the polyisocyanate has been applied but preferably before the dispersion is applied; this is believed to promote additional curing and hardening at the surface of the applied coating.

In still another embodiment, the isocyanate trimerization catalyst and dispersion of finely divided particles are combined into one component of a two-component coating composition, the second component being the polyisocyanate. Such a two-component coating composition can be applied by mixing the components and applying them together or by first applying the polyisocyanate component and then applying the catalyst/dispersion mixture, followed by curing.

The amount of coating composition applied is sufficient to provide 0.1 to 10 parts by weight of the polyisocyanate component per 100 parts by weight of the substrate particles. A preferred amount is sufficient to provide 0.1 to 5, 0.1 to 2.5, or 0.1 to 1.5 parts by weight of the polyisocyanate component, on the same basis.

The coating composition (or any component thereof) can be applied by spraying or other suitable method. The substrate particles are preferably stirred or otherwise agitated. They may be, for example, disposed in a fluidized bed, in a stirred container or other device that permits the particles to be separated and individually coated. The ability to spray the coating composition onto the substrate particles is an advantage of this invention.

Curing is performed at an elevated temperature, such as up to 140° C. The elevated temperature preferably is at least 50° C. or at least 60° C. and may be up to 120° C., up to 100° C., 90° C. or up to 80° C. Another advantage of this invention is that the coating cures rapidly at such moderately elevated temperatures to form free flowing coated proppant particles. The curing time at such temperatures is typically no greater than 10 minutes and may be as short as one minute. A typical curing time may be 1 to 5 minutes or 2 to 5 minutes.

It is generally convenient to heat the substrate particles to the curing temperature before applying the coating composition. The applied coating composition in such cases may be heated to the curing temperature by transfer of heat from the substrate particles, without the need to apply further heating during the curing process. However, it is possible to apply the coating composition to unheated substrate particles and heat the substrate particles and applied coating together to the curing temperature.

Agitation should be provided during the curing step to avoid agglomeration.

Curing produces isocyanurate linkages in situ on the surface of the particle as the curing reaction takes place. Other types of linkages formed in the reaction of an isocyanate group with itself or other species, are formed in at most minor amounts (typically 5 mole-% or less based on total moles of linkages formed in the reaction of one or more isocyanates)) due to the lack of effective amounts of urethane, urea and carbodiimide catalysts (and the poor catalytic activity of the isocyanate trimerization catalyst toward reactions that form such groups). As a result, curing and solidification of the liquid starting polyisocyanate takes place mainly through the formation of isocyanurates. In the presence of the isocyanate trimerization catalyst, these linkages form rapidly at the moderate temperatures described above. The relative proportions of isocyanurate linkages and other linkages formed in the reaction of an isocyanate group with itself or other species can be determined using infrared spectroscopy, by comparing the intensities of the absorption signals.

The resulting coated proppant particles can be used in the same manner as conventional proppant particles. In a typical hydraulic fracturing operation, a hydraulic fracturing composition, comprising a fracturing fluid, the coated proppant, and optionally various other components is prepared. The fracturing fluid can be a wide variety of fluids such as kerosene and water. Various other components that can be added to the mixture include, but are not limited to, guar, polysaccharides and other thickeners, and well as other components as may be useful.

The fracturing fluid may contain a gelling agent to help prevent the proppant particles from settling prematurely. Such a gelling agent may be dissolved once the formation has been fractured to allow the proppant particles to deposit into the fractures.

The mixture is pumped into the subterranean formation under pressure to create or enlarge fractures in the subterranean formation. Coated proppant particles enter into the fractures and are retained there. When the hydraulic pressure is released, the coated proppant holds the fractures open, thereby maintaining a flow path through the fractures to facilitate the extraction of petroleum fuels or other fluids from the formation to the wellbore.

Another advantage of the invention is that the coated proppant bonds to itself under conditions of elevated temperature and pressure. This property permits the coated proppants to form agglomerated masses within the subterranean fracture. The agglomerated masses are more resistant to proppant flowback than are the individual proppant particles.

The ability of the coated proppant to bond to itself can be measured in accordance with the unconfined compressive strength (UCS) test described in the following examples. When bonded together under conditions of 1000 psi (6.89 MPa) and 70° C. for 16 hours, the compressive strength of the resulting bonded mass, as measured by the USC test, is in preferred embodiments at least 40 kPa. The compressive strength on this test may be at least 70 kPa or at least 100 kPa and may be up to 500 kPa or up to 300 kPa.

The following examples are provided to illustrate the invention, and are not intended to limit the scope thereof. All parts and percentages are by weight unless otherwise indicated.

Polyisocyanate A is a polymeric MDI product having an isocyanate functionality of 2.7 isocyanate groups per molecule and an isocyanate content of 30.4-32.0%.

Polyisocyanate B is a polymeric MDI product having an isocyanate functionality of 2.2-2.3 isocyanate groups per molecule and an isocyanate content of 32.1-33.3%.

Polyisocyanate C is a polymeric MDI product having an isocyanate functionality of 2.3 isocyanate groups per molecule and an isocyanate content of 31.3-32.6%.

Polyisocyanate D is a polymeric MDI product having an isocyanate functionality of 3.2 isocyanate groups per molecule and an isocyanate content of 29.0-31.3%.

Catalyst A is a 2-(hydroxylpropyl)trimethylammonium formate product in a hydroxylic carrier, available commercially from Air Products as Dabco® TMR-2 catalyst.

Catalyst B is a quaternary amine trimerization catalyst product in a hydroxylic carrier, available commercially from Air Products as Dabco® TMR-7 catalyst.

Catalyst C is a quaternary amine trimerization catalyst product in a hydroxylic carrier, available commercially from Air Products as Dabco® TMR-18 catalyst.

Catalyst D is a quaternary amine trimerization catalyst product in a hydroxylic carrier, available commercially from Air Products as Dabco® TMR-20 catalyst.

Catalyst E is a 1:2.7 by weight blend of 3-methyl-1-phenyl-2-phospholene-oxide in glycerol.

The fumed silica is a 30% solids, alkaline dispersion of submicron-sized fumed silica particles in an aqueous phase.

The sand used in the following experiments is a 40/70 mesh sand product.

### EXAMPLES 1-11 AND COMPARATIVE SAMPLES A-G

Standard coating procedure for Examples 1-10: 750 grams of sand are preheated to the coating temperature indicated in Table 1 and loaded into a Hobart type laboratory mixer. Separately, a blend of polyisocyanate and catalyst as indicated in Table 1 is prepared and added to the preheated sand with vigorous mixing. After mixing for one minute, the fumed silica dispersion is added and mixing is continued another two minutes. The free-flowing sand product thus obtained is discharged into plastic bags and stored at room temperature for several days before being evaluated for unconfined compressive strength (UCS).

For Example 11, the standard coating procedure is modified in that the polyisocyanate and catalyst are added to the sand separately but simultaneously.

Under these curing conditions (temperature, time, presence of trimerization catalyst and absence of urethane catalyst) the polyisocyanate reacts predominately with itself to form isocyanurates. A small quantity of ureas may form due to reaction of isocyanate groups with water, and a small amount of other linkages such as biurets may form, but these groups including any urea groups as may form are present in amounts of less than 5 mole-%.

Comparative Sample A is uncoated sand. Comparative Samples B-E are made using the standard coating procedure, but the trimerization catalyst is omitted. In Comparative Samples D and E, a carbodiimide catalyst rather than a trimerization catalyst is present. In Comparative Example F, only the fumed silica dispersion is coated on the sand. In Comparative Example G, trimerization catalyst is omitted but the fumed silica dispersion is added. The formulations are as reported in Table 1.

UCS is measured by first sieving the coated sand through 1 mm metal screens. The sieved sand is mixed with a solution of 2% potassium chloride in water, at a volume ratio of 4 parts sand to 3 parts solution. 1 drop of dish soap is added to eliminate air entrainment. The resulting slurry is allowed to stand for 5 minutes and then loaded into a 1.125-inch (28.6 mm) interior diameter steel cylindrical cell with removable top and bottom assemblies. Excess water is drained from the cell. A piston is placed at the top of the sample chamber and hammered into the cell. The top assembly equipped with a pressure relief valve and a nitrogen inlet is attached to the cell. The cell is pressurized to 1000 psi (6.89 MPa) with nitrogen, then kept overnight in a 70° C. oven. The cell is then cooled to room temperature. The sand plug is removed from the cell and dried under ambient conditions for a day to remove absorbed water. The plug is then broken into 2-inch (5.08 cm) pieces and filed at the edges to smooth them. Plugs are tested for compressive strength using an MTS insight electromechanical testing system with a 2000 kilonewton load cell and a compression rate of 0.01 in/minute (0.254 mm/minute). The peak stress value is reported as the USC.

TABLE 1

| | | | | | | Fumed | | |
|---|---|---|---|---|---|---|---|---|
| | | | | | | Silica | | |
| | | Polyisocyanate | | Catalyst | | Dispersion, | Curing Conditions | |
| Sample | Sand, pbw | Type | pbw | Type | pbw | pbw | Temp., ° C. | Time, s |
| A* | 750 | Untreated Sand | | | | | | |
| B* | 750 | A | 7.5 | None | | None | 60 | 120-180 |
| C* | 750 | B | 7.5 | None | | None | 60 | 120-180 |
| D* | 750 | A | 7.5 | E | 0.34 | None | 60 | 120-180 |
| E* | 750 | B | 7.5 | E | 0.34 | None | 60 | 120-180 |
| F* | 750 | None | 0 | None | 0 | 10.2 | 60 | 120-180 |
| G* | 750 | A | 7.5 | None | 0 | 10.2 | 70 | 120-180 |
| 1 | 750 | A | 7.5 | A | 0.09 | 10.2 | 60 | 120-180 |
| 2 | 750 | A | 7.5 | B | 0.15 | 10.2 | 60 | 120-180 |
| 3 | 750 | A | 7.5 | C | 0.09 | 10.2 | 60 | 120-180 |
| 4 | 750 | A | 7.5 | D | 0.15 | 10.2 | 60 | 120-180 |
| 5 | 750 | A | 7.5 | A | 0.13 | 8.4 | 70 | 120-180 |
| 6 | 750 | A | 7.5 | A | 0.20 | 6 | 70 | 120-180 |
| 7 | 750 | A | 5.0 | A | 0.06 | 5.4 | 60 | 120-180 |
| 8 | 750 | A | 3.8 | A | 0.06 | 5.4 | 60 | 120-180 |
| 9 | 750 | B | 7.5 | A | 0.27 | 9.6 | 70 | 120-180 |
| 10 | 750 | C | 7.5 | A | 0.18 | 10.2 | 70 | 120-180 |
| 11 | 750 | D | 7.5 | A | 0.4 | 10.2 | 70 | 120-180 |

*Comparative.
“pbw” means parts by weight.

TABLE 2

| | Coated Sand | | |
|---|---|---|---|
| Sample | Characteristics | UCS, kPa (psi) | |
| A* | Free flowing | 0 | |
| B* | Completely aggregated | NM | |
| C* | Completely aggregated | NM | |
| D* | Completely aggregated | NM | |
| E* | Completely aggregated | NM | |
| F* | Free Flowing | 0 | |
| G* | Not free flowing | NM | |
| 1 | Free flowing | 165 | (24) |
| 2 | Free flowing | 200 | (29) |
| 3 | Free flowing | 193 | (28) |
| 4 | Free flowing | 165 | (24) |
| 5 | Free flowing | 241 | (35) |
| 6 | Free flowing | 159 | (23) |
| 7 | Free flowing | 48 | (7) |
| 8 | Free flowing | 41 | (6) |
| 9 | Free flowing | 152 | (22) |
| 10 | Free flowing | 145 | (21) |
| 11 | Free flowing | 117 | (17) |

*Comparative.
NM means “not measured” due to agglomeration.

As the data in Table 2 shows, uncoated sand is free flowing but does not bond under the UCS test conditions.

In the absence of a catalyst (Comparative Samples B, C and G), the polyisocyanate does not cure under these conditions and the sand becomes completely or partially aggregated during the coating process. Adding a carbodiimide catalyst (Comparative Samples D and E) does not promote curing under these conditions, again leading to complete aggregation of the sand as it is coated. In absence of polyisocyanate (Comparative Example F), sand is not able to bond with other particles and has no UCS.

In contrast, the coating formulations of Examples 1-11 each cure within 3 minutes at a moderate temperature of 60-70° C. The coated sand in each case flows freely, as does the untreated sand of Example 1. In the UCS test, the coated sand bonds to form a strong plug. The lower UCS values of Examples 7 and 8 are believed to be attributable to the lower coating weights.

### EXAMPLES 12-14

Spray-coated sand is made as follows: The polyisocyanate and catalyst are mixed at room temperature on a high-speed laboratory mixer. The sand is preheated to 70° C. and loaded into a Hobart type mixer. The polyisocyanate/catalyst blend is sprayed onto the sand as it is mixed in the mixer, using a Paasche VL Airbrush spray operated at a pressure of 3800-5000 kPa (80-100 psi). After the coating composition has at least partially cured, the fumed silica dispersion is sprayed onto the sand in the same manner. The resulting free flowing coated sand is discharged into a plastic bag after a cycle time (coating and curing) of 120-180 seconds. The coated sand tested for the UCS. Formulation details, coating conditions and UCS values are as described in the table below:

TABLE 3

| Example | 12 | 13 | 14 |
|---|---|---|---|
| Sand, pbw | 750 | 750 | 750 |
| Polyisocyanate A, pbw | 7.3 | | |
| Polyisocyanate B, pbw | | 7.5 | |
| Polyisocyanate C, pbw | | | 7.5 |
| Catalyst A, pbw | 0.09 | 0.18 | 0.27 |
| Fumed Silica | 9.3 | 10.0 | 10.1 |
| dispersion, pbw | | | |
| Coating temp., ° C. | 70 | 70 | 70 |
| Cycle time, sec. | 120-180 | 120-180 | 120-180 |
| UCS, kPa (psi) | 76 (11) | 48 (7) | 103 (15) |

Good results are obtained in a spray coating process. The sand does not aggregate when coated yet bonds well under heat and pressure.

Examples 12-14 also demonstrate that the fumed silica can be added to the proppant separately, after the polyisocyanate and catalyst have been applied.

### EXAMPLES 15-17

10 parts of Polyisocyanate A and 0.12 part of Catalyst A are mixed at room temperature on a high speed laboratory mixer. The sand is preheated to 70° C. and loaded into a Hobart type mixer. The polyisocyanate/catalyst mixture is combined with the sand as the sand is mixing, and allowed to cure for 1 minute. An additional amount of Catalyst A is then added, and the fumed silica dispersion sprayed onto the coated sand using a Paasche VL Airbrush sprayer. Total cycle time is 2-3 minutes. Free flowing coated sand obtained at the end of the coating process is discharged into plastic bag and tested for the UCS. Formulation details, coating conditions and UCS values are described in the table below.

| Example # | 15 | 16 | 17 |
|---|---|---|---|
| Sand, pbw | 750 | 750 | 750 |
| Polyisocyanate A/Catalyst | 7.5 | 7.5 | 7.5 |
| A blend, pbw | | | |
| Second Catalyst A addition, pbw | 0.4 | 0.3 | 0.2 |
| Fumed Silica Dispersion, pbw | 2.6 | 6.5 | 8.5 |
| UCS, kPa, (psi) | 90 (13) | 110 (16) | 200 (29) |

By adding more catalyst after the initial coating has been applied and at least partially cured, the amount of fumed silica can be reduced while still obtaining a free-flowing product that bonds well under applied heat and pressure.

1. A method for forming a coated proppant, comprising applying a coating composition to the surface of solid substrate particles, wherein the solid substrate particles are thermally stable to a temperature of at least 100° C., wherein the coating composition comprises at least one polyisocyanate and an isocyanate trimerization catalyst, and curing the coating composition at an elevated temperature for a period of up to 10 minutes on the surface of the substrate particles to form a solid polymeric coating at the surface of the solid substrate particles, thereby forming the coated proppant.

2. The method of claim 1 wherein the coating composition contains no more than 0.1 part by weight, per 100 parts by weight of the polyisocyanate, of urethane, urea and carbodiimide catalysts.

3. The method of claim 2 wherein the coating composition further comprises finely divided fumed silica.

4. The method of claim 3 wherein the coating composition contains no more than 10 parts by weight, per 100 parts by weight of polyisocyanates of an alcohol, and not more than 5 parts by weight, per 100 parts by weight of polyisocyanates, of a primary amine and/or secondary amine compound.

5. The method of claim 3 the coating composition is applied to the surface of the substrate particles and at least partially cured, and finely divided fumed silica is thereafter applied to the coated particles.

6. The method of claim 3 wherein the coating composition is applied to the surface of the substrate particles, additional isocyanate trimerization catalyst is then applied to the coated particles, the coating composition is at least partially cured, and an aqueous dispersion of finely divided fumed silica is thereafter applied to the coated particles.

7. The method of claim 3 wherein the coating composition is sprayed onto the substrate particles.

8. The method of claim 3 wherein the coating composition is cured at a temperature of 60 to 90° C.

9. The method of claim 3 wherein the amount of the coating composition applied to the surface of the substrate particles is sufficient to provide 0.1 to 10 parts by weight of polyisocyanate per 100 parts by weight substrate particles.

10. The method of claim 3 wherein the polyisocyanate is a polymeric MDI.

11. The method of claim 3 wherein the substrate particles are sand.

12. A coated proppant particle made in the method of claim 1.

13. A coated proppant particle comprising a substrate particle having a polymeric coating that weighs 0.1 to 10 weight percent of the weight of the substrate particle, wherein the polymeric coating is a polyisocyanurate polymer that contains no more than 10 mole-% urethane, urea and/or carbodiimide linkages.

14. The coated proppant particle of claim 13 wherein fumed silica particles are embedded in and/or adhered to the surface of the polymeric coating.

15. A method of hydraulically fracturing a subterranean formation, comprising injecting a carrier fluid and coated proppant particles of claim 13 into the subterranean formation to cause the subterranean formation to form fractures, whereby at least a portion of the coated proppant particles are retained in the fractures.
